(19) United States
(12) Patent Application Publication
(10) Pub. No.: US 2011/0068513 A1
(43) Pub. Date: Mar. 24, 2011

(54) STRETCH BLOW MOLDED CONTAINER AND METHOD

(75) Inventor: Richard C. Darr, Medina, OH (US)

(73) Assignee: Plastipak Packaging, Inc., Plymouth, MI (US)

(21) Appl. No.: 12/889,784

(22) Filed: Sep. 24, 2010

Related U.S. Application Data
(60) Provisional application No. 61/245,522, filed on Sep. 24, 2009.

(51) Int. Cl. B29C 49/64; B29C 49/06

(52) U.S. Cl. 264/492; 264/535

(57) ABSTRACT

A method for making a container is disclosed. In an embodiment, the method includes providing a preform; applying heat or energy to at least a portion of the preform to bring the portion to an elevated temperature and so an inner surface of the preform is heated; and applying an air flow to the preform. In an embodiment an airflow of at least about 2,200 ft/min to maintain a temperature differential between the inner surface and the outside surface of the portion of the preform being heated to within about 20° F. The preform may subsequently be blow molded to form a container. In embodiments of the invention, polypropylene preforms may be used in connection with injection-stretch blow molding (ISBM) technologies for high-speed production of polypropylene containers.

### CROSS-REFERENCE TO RELATED APPLICATION

This application claims the benefit of U.S. Provisional Application No. 61/245,522, filed Sep. 24, 2009, which is hereby incorporated by reference as though fully set forth herein.

### TECHNICAL FIELD

The present invention relates in general to stretch blow molded containers, including containers comprised of polypropylene, and to methods for making such containers.

### BACKGROUND

Injection stretch blow molding (ISBM) is a technology that is known in the container industry. The use of ISBM technologies can allow for high-speed production of plastic containers. ISBM technology is commonly used in the production of polyethylene terephthalate (PET) containers. Polypropylene or polypropene (PP) is thermoplastic polymer also known in the field of plastic containers. Containers made with polypropylene may be rugged and resistant to many chemicals, and polypropylene containers are known to have many uses. However, the conventional processes for producing polypropylene containers generally do not achieve the high-speed production rates associated with ISBM technologies in the context of PET, as the plastic properties of polypropylene differ greatly from PET. Among other things, polypropylene typically has a lower density and specific heat than PET hence it can exhibit a narrower processing window. Moreover, polypropylene is typically more opaque than PET, which can detract from its visual/aesthetic appearance. Consequently, one cannot simply apply PET technology to PP preforms and containers and expect to inherently achieve the same or even similar results from a product or production standpoint.

Typically with an ISBM process, a plastic preform is formed and transported to a blow molder or blow molding machine. Prior to entering the blow molder, the preform will usually be heated to raise the temperature of the plastic to a point that permits stretching the preform in a mold. There is some amount of time t that occurs between the time the preform is heated to the time the preform enters the mold to be blow molded. During this period of time t, the preform will naturally lose heat, as the surrounding temperature is usually significantly below that of the heated preform. This can present challenges. If the temperature of the materials comprising the preform is too low in the blow molder, the preform may not stretch properly. However, if the preform is heated to too high a temperature, depending on the thickness of the preform, the outside of the preform may be overheated or “burned.”

Heat can be applied to preforms in a number of ways. Without limitation, some known methods for heating preforms involve the application of infrared energy and quartz lamps. However, conventionally, the heat source is provided outside of the preform, and the energy or heat must penetrate the preform body from the outside to the inside. Because it is often desired that the inside of the preform is provided at a sufficient temperature T, simply applying heat in such methods will generally result in the inside of the preform having a temperature T, and the outside of the preform having a higher temperature, for example, T+10° F. With such methods, there is a risk that the result of achieving a desired inside temperature is an undesirable outside temperature, which in turn can lead to problems in blow molding a resultant container.

Some conventional ISBM machines incorporate ventilation to cool the temperature on the outside of the preform, at or about the time the preform is heated, in an attempt to better balance the temperatures on the inside and outside portions of the preform. Ventilation systems known in the art involve air flow that is provided at about 800 feet per minute. Such ventilation is usually acceptable in connection with standard PET bottles, but is insufficient for injection stretch blow molding polypropylene containers. Moreover, preforms that involve higher degrees of orientation commonly require enhanced airflow, as the equilibrium of the temperatures between the inside and outside portions of the preform can be a factor in producing a commercially acceptable container.

Polypropylene preforms can be run on standard ISBM machines that are typically adapted for PET containers. However, such polypropylene preforms will commonly fail at the heating zone. Where typical polypropylene preforms may require a temperature coming out of heating at about 230° F. when such preforms are run on conventional ISBM machines, the inside temperature of the preform is typically about 10° F. cooler than the outside temperature of the preform. However, as noted, it is often desirable to provide a preform having a temperature balance or equilibrium, i.e., where the inside-outside temperature differential is at or near 0° F.

### SUMMARY

A method for making a container is disclosed. In an embodiment, the method includes providing a preform; applying heat or energy to at least a portion of the preform to bring the portion to an elevated temperature and so an inner surface of the preform is heated; and applying an air flow to the preform. In an embodiment an airflow of at least about 2,200 ft/min to maintain a temperature differential between the inner surface and the outside surface of the portion of the preform being heated to within about 20° F. The preform may subsequently be blow molded to form a container. In embodiments of the invention, polypropylene preforms may be used in connection with injection-stretch blow molding (ISBM) technologies for high-speed production of polypropylene containers.

### BRIEF DESCRIPTION OF THE DRAWINGS

Embodiments of the invention will now be described, by way of example, with reference to the accompanying drawings, wherein:

FIG. 1 is a perspective illustration of a centrifugal blower that may be used in a process for blow molding a preform;

FIG. 2 generally represents an airflow diagram associated with a blower of the type shown in FIG. 1;

FIG. 3 is a perspective illustration of a ducted blower that may be used in connection with embodiments of the invention;

FIG. 4 is a perspective illustration of a blower unit comprised of a plurality of ducted blowers;

FIGS. 5 and 6 generally illustrates preforms configured in accordance with an embodiment of the invention;

FIGS. 7 and 8 generally illustrate containers formed in accordance with teachings of the invention;

FIGS. 9 and 10 generally illustrate other containers formed in accordance with teachings of the invention; and

FIGS. 11 and 12 generally illustrate enlarged partial views associated with FIGS. 9 and 10.

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

The present invention recognizes that with preforms it can be desirable to provide a heated preform to an ISBM process that has an inside-outside temperature balance or equilibrium that may approach 0° F. In an embodiment of the invention, the ISBM process may be modified such that airflow via blowers, which may be located behind heat shields, is provided to be at least 2,200 feet per minute. Notably, for some embodiments, the blower airflow may be provided at least at 3,000 feet per minute. For example, in an embodiment of the invention, such an airflow may be accomplished by providing comparatively larger, ducted blowers that substantially uniformly and controllably distribute airflow across the face of the preform.

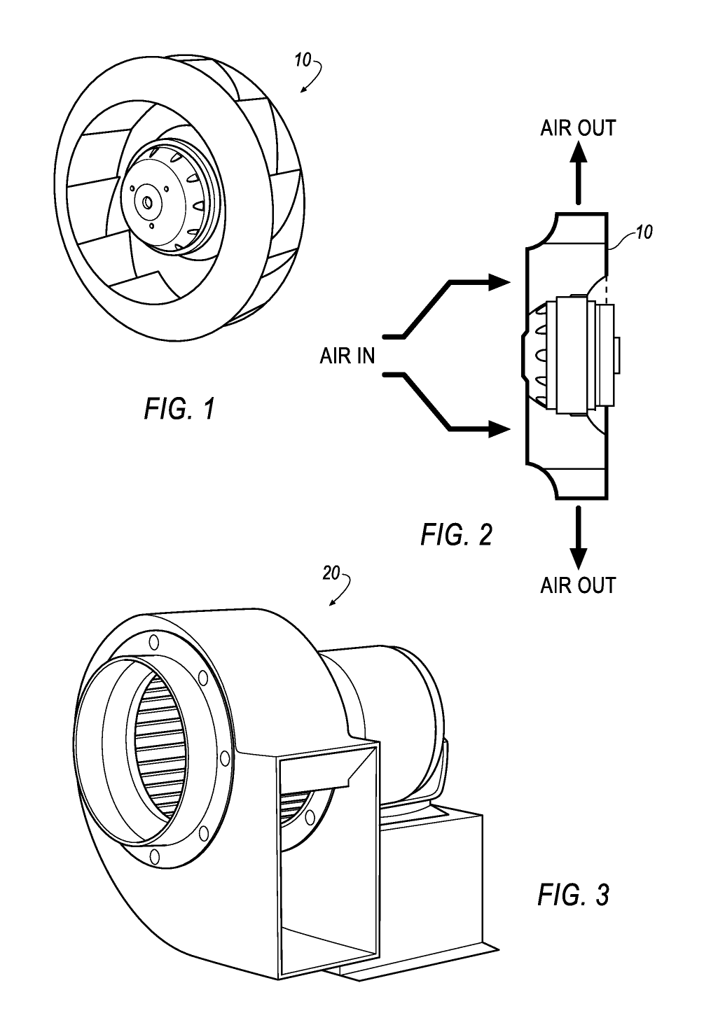

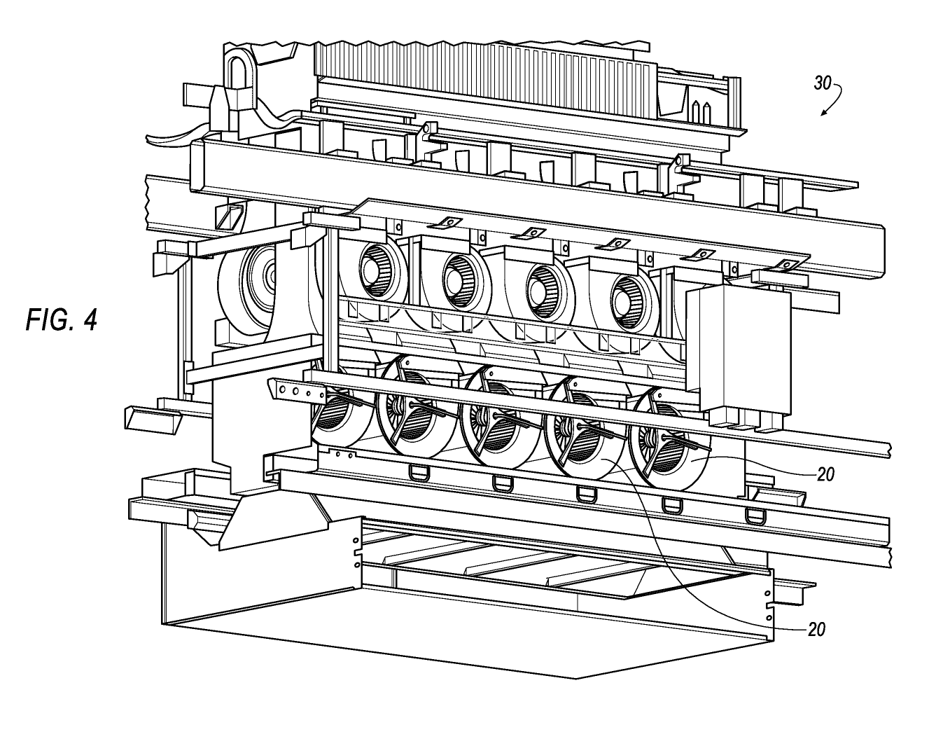

FIG. 1 generally illustrates an example of a centrifugal blower 10 that may be provided behind a heat shield in connection with an ISBM process for blow molding a PET preform. FIG. 2 generally represents an airflow diagram associated with a blower of the type shown in FIG. 1. However, it has been discovered that the airflow associated with such conventional blowers is generally too low to be useful for polypropylene processing. Moreover, as generally illustrated in FIG. 2, such conventional blowers may provide a non-uniform flow based on the associated fan design. The present invention envisions, among other things, providing heat or energy (for example, via infrared or quartz heaters/lamps) to at least the outside of a preform (e.g., to indirectly heat the inner surface or portion of the preform), and the use of blowers that are capable of providing a significantly increased air flow (e.g., 2,200 feet per minute or more) in a more uniform manner to preforms—which may include polypropylene preforms. Without limitation, an example of a larger, ducted blower 20 that may be used in connection with the present invention is generally illustrated in FIG. 3. Moreover, as generally illustrated in FIG. 4, a plurality of ducted blowers 20 may be combined into a blower unit 30. The preforms may then be stretch blow molded in a subsequent operation to form a resultant container.

Further, it has been discovered that such alterations with respect to the method employed for cooling the preforms can allow for the use of thicker preforms—including significantly thicker preforms than those previously used in the industry. That is, the ability to heat the preforms at higher temperatures and/or for longer durations, based on increased ventilation power, can permit preform designs to include greater wall thickness (as a thicker wall requires more heat or time to bring the inside of the preform to a desired temperature). Moreover, the ability to utilize increased wall thickness can provide for better wall distribution in certain container configurations, and portions thereof, including for containers of at least 1 liter, and potentially for containers of 2 liters or greater content volume.

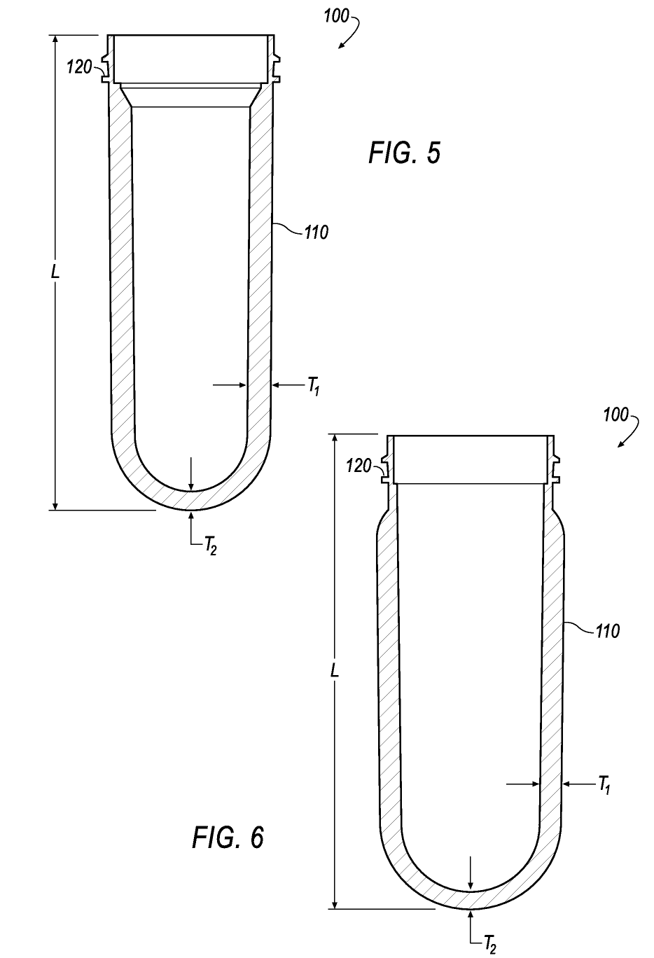

FIGS. 5 and 6 generally illustrates preforms 100, which may be comprised of polypropylene, that are configured in accordance with teachings of the present invention. The exemplary preform 100 illustrated in FIG. 5 may, for instance, have a wall thickness that exceeds 6 mm and a body weight of about 70±2 grams. By way of example, and without limitation, with reference to FIG. 5, the preform may have a total height, or length L, of 5.056 inches (128.42 mm)±0.06 inches (1.524 mm), and the preform may have a sidewall thickness T₁ of 0.243 inches (6.17 mm)±0.01 inches (0.254 mm), and a bottom thickness T₂ of 0.194 inches (4.93 mm)±0.01 inches (0.254 mm). The exemplary preform 100 illustrated in FIG. 6—which includes a reverse taper configuration—may have a wall thickness of less than 6 mm (e.g., 5.9 mm) and a body weight of 75±2 grams. By way of example, and without limitation, with reference to FIG. 6, the preform may have a total height, or length L, of 5.031 inches (127.79 mm)±0.06 inches (1.524 mm), and the preform may have a sidewall thickness T₁ of 0.233 inches (5.92 mm)±0.01 inches (0.254 mm), and a bottom thickness T₂ of 0.186 inches (4.72 mm)±0.01 inches (0.254 mm). Further, as generally illustrated in FIG. 6, the preform 100 may also provide a body 110 that is wider (in diameter) than the associated support ledge 120. Among other things, the present invention may permit the production and use of “shorter” preforms, including polypropylene preforms. For example, without limitation, such preforms 100 may be used to form 2040 ml polypropylene containers, but may have lengths L (e.g., 4.862±0.30 inches and 4.848±0.30 inches, respectively) that are similar to lengths associated with preforms used to form 600 ml and 1080 ml containers. Moreover, preforms 100 may be subjected to L/L draws that are greater than 2.

Moreover, by providing better control of the temperatures associated with the inside and outside portions of the preforms, including polypropylene preforms, the quality of the resulting containers may be improved. In an embodiment, the temperature of the outer surface of a preform may be provided/maintained within the range of about 240° F. to 245° F. In such a context, it is has been found to often be desirable to keep the outer surface temperature at or below about 250° F. With respect to such embodiments, the temperature on the inner surface of the preform may be provided/maintained within the range of about 240° F. to about 280° F.

Further, it has been found that significant advantages can be obtained by such purposeful control of the inside and outside temperatures of the preform (as well as the differential therebetween). Among other things, controlling the heating as such, and preventing the overheating of the preform, can result in a container with significantly less haze—that is, a container that is quantitatively less “cloudy.” Polypropylene containers that are injection stretch blow molded in accordance with the teachings of the invention may have reduced haze factors (i.e., transmission haze). For instance, the transmission haze for a number of common container volumes can be less than 35.0. Moreover, it has been found that the associated haze factor will generally decrease the more the stretch ratio (expansion of preform to resultant container) increases. For example, without limitation, embodiments of 600 ml, 1080 ml, and 2040 ml containers may exhibit transmission hazes that are less than 35.0, less than 33.0, and less than 25.0, respectively. This can be quite desirable as polypropylene typically begins as a more hazy resin than PET, and conventional PP container production methods known in the industry commonly result in container with haze factors that are aesthetically not acceptable to many industries and customers. By being able provide a “clearer” PP container, more industry categories may have an option for product packaging. “Transmission haze” may be described as a forward scattering of light from the surface of a nearly clear specimen viewed in transmission. Transmission haze can be measured, for example, using conventional instruments, e.g., a HunterLab D25P sensor (which was used to measure the aforementioned transmission hazes). Additional information concerning the measurement of haze may be found, without limitation, in HunterLab Application Note, vol. 9, no. 6 (06/08) (Insight on Color).

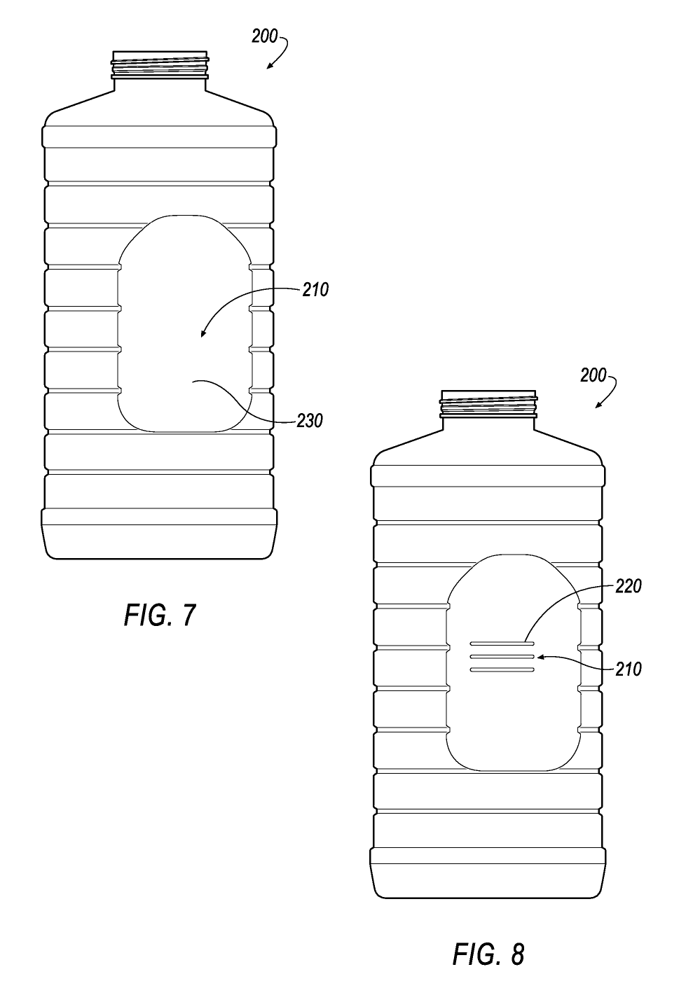

Without limitation, examples of polypropylene containers 200 formed in accordance with the teachings of the present invention are illustrated in FIGS. 7 and 8. As generally illustrated, if desired, such containers 200 may include grip portions, generally designated 210. It has been found that the grip portion 210 configuration illustrated in FIG. 7 can provide some additional benefits when compared to the configuration shown in FIG. 8. For example, the removal of the horizontal ribs 220 generally shown in FIG. 8 can be beneficial for some designs. Further, the extended oval finger well 230 can help to eliminate bending. While those features were specifically mentioned, it is important to note that the invention is not so limited, and various other structural configurations are also within the scope and spirit of the invention.

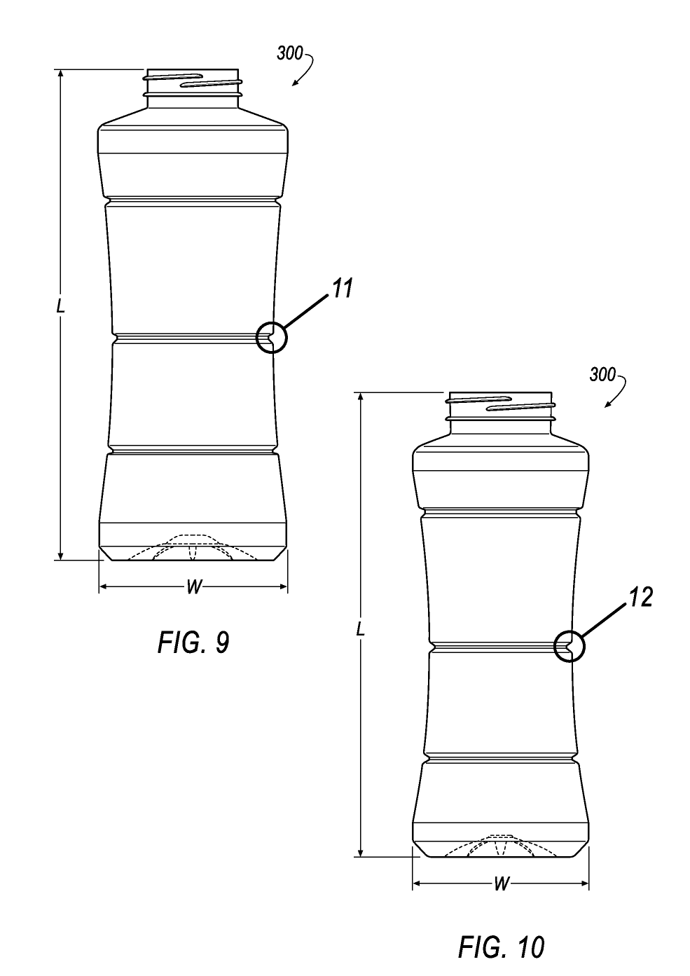

Without limitation, yet further examples of polypropylene containers 300 formed in accordance with the teachings of the present invention are illustrated in FIGS. 9 and 10. By way of example, without limitation, the container 300 shown in FIG. 9 may have a total height, or length L, of 9.432 inches (239.57 mm)±0.060 inches (1.524 mm), and a base width W of 3.650 inches (92.71 mm)±0.060 inches (1.524 mm). Similarly, and without limitation, the container 300 shown in FIG. 10 may have a total height, or length L, of 8.100 inches (205.74 mm)±0.060 inches (1.524 mm), and a base width W of 3.071 inches (78.00 mm)±0.060 inches (1.524 mm).

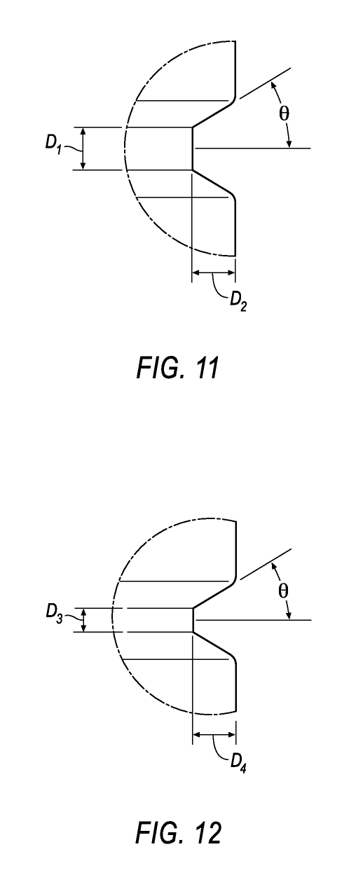

FIGS. 11 and 12 generally illustrate enlarged section views of portions of the sidewalls identified in FIGS. 9 and 10, respectively. For example and without limitation, with respect to the portions (or rib portions) shown in FIGS. 11 and 12, the rib angle θ may be 30°±5°; the rib widths D₁ and D₃ may be 0.100 inches (2.54 mm)±0.05 inches (1.27 mm) and 0.056 inches (1.42 mm)±0.03 inches (0.762 mm); and the rib inset distances D₂ and D₄ may be 0.100 inches (2.54 mm)±0.05 inches (1.27 mm).

Further, in addition to providing for polypropylene containers with improved qualities, the invention can facilitate improved production times. For example, conventional ISBM manufacturing of polypropylene containers would result in containers of lesser quality being run at speeds of about 600 to 650 containers per hour, per cavity. By implementing the teachings of the present invention as discussed herein, containers of a higher quality may be produced at speeds of 900 or more containers per hour, per cavity—an efficiency increase of at least 38%, and perhaps as much as 50% or more.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims and their equivalents.

What is claimed is:

1. A method for making a container comprising:
providing a preform;
applying outside heat or energy to at least a portion of the preform to an elevated temperature, such that the heat or energy heats an inner surface of the preform; and
applying an airflow to the preform of at least about 2,200 ft/min to maintain a temperature differential between the inner surface and the outside surface of the portion of the preform being heated to within about 20° F.

2. The method of claim 1, including blow molding the preform to form a container.

3. The method of claim 1, wherein the preform is comprised of polypropylene.

4. The method of claim 1, wherein the airflow applied to the preform is provided at least at about 3,000 ft/min.

5. The method of claim 1, wherein the airflow applied to the preform is provided substantially uniformly and controllably distribute airflow across the face of the preform.

6. The method of claim 1, wherein the outside heat or energy is provided by an infrared heater or lamp.

7. The method of claim 1, wherein the outside heat or energy is provided by a quartz heater or lamp.

8. The method of claim 1, wherein the preform has a sidewall thickness that exceeds 6 mm and a body weight of about 70±2 grams.

9. The method of claim 1, wherein the preform has a reverse taper configuration, a sidewall thickness of less than 6 mm, and a body weight of about 75±2 grams.

10. The method of claim 1, wherein a portion of the body of the preform extends further radially outward than a support ledge provided in the neck portion of the preform.

11. The method of claim 1, wherein the preform is molded to form a 2040 ml container, and the preform has a length o 4.848±0.30 inches.

12. The method of claim 1, wherein a resultant container is formed from the preform and the length of the resultant container is greater than two times the length of the preform.

13. The method of claim 1, wherein the temperature of the outer surface of the preform is provided or maintained below about 250° F.

14. The method of claim 1, wherein the temperature of the outer surface of the preform is provided or maintained within the range of about 240° F. to 245° F.

15. The method of claim 1, wherein the temperature of the inner surface of the preform is provided or maintained within the range of about 240° F. to 280° F.

16. The method of claim 1, wherein a container is formed from the preform by injection stretch blow molding, and the container has a transmission haze less than 35.0.

17. The method of claim 1, wherein a container is formed from the preform by injection stretch blow molding, and the container has a transmission haze less than 33.0.

18. The method of claim 1, wherein a container is formed from the preform by injection stretch blow molding, and the container has a transmission haze less than 25.0.

19. The method of claim 1, wherein a container is formed from the preform, and the container includes a grip portion.

20. The method of claim 1, wherein containers are produced at a rate of 900 or more per hour.
